(19) United States
(12) Patent Application Publication
(10) Pub. No.: US 2008/0228510 A1
(43) Pub. Date: Sep. 18, 2008

(54) METHOD FOR RESERVING EQUIPMENT AND COMPUTER ACCESSIBLE STORAGE MEDIA TO STORE PROGRAM THEREOF

(75) Inventors: Shih-Chang Chang, Hsinchu City (TW); Wei Chen, Hsinchu County (TW); De-Lung Wu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: POWERCHIP SEMICONDUCTOR CORP., Hsinchu (TW)

(21) Appl. No.: 11/779,292

(22) Filed: Jul. 18, 2007

(30) Foreign Application Priority Data
Mar. 13, 2007 (TW) 96108543

(51) Int. Cl. G06Q 10/00

(52) U.S. Cl. 705/1

(57) ABSTRACT

A method for reserving equipment is provided. In the present invention, an arrival time in each site of a special lot is forecasted according to a history record, and the equipment is reserved according to the arrival time and a status of each of the equipments at the site. As a result, suitable equipments in the production line are reserved for the special lot, thus the time of waiting for idle equipment can be eliminated, and the cycle time of processing special lot can be reduced.

### CROSS-REFERENCE TO RELATED APPLICATION

This application claims the priority benefit of Taiwan application serial no. 96108543, filed Mar. 13, 2007. All disclosure of the Taiwan application is incorporated herein by reference.

### BACKGROUND OF THE INVENTION

1. Field of the Invention

The present invention generally relates to a method for reserving equipments, and more particularly, to method for reserving equipments for processing a special lot.

2. Description of Related Art

As competition in semiconductor industry is becoming increasingly intense, in order to reduce a cycle time to increase company's revenue, how to effectively manage various equipments in a wafer fabrication factory and avoid product stocking for maximizing throughput of the equipments is without doubt one of the most important issues for current semiconductor companies. Taking a contemporary process for a lot as an example, when arriving at each site of the wafer factory, work-in-process (WIP) must wait until the equipment at the site is available for processing.

However, with respect to a batch of WIPs of high priority which processing course and result must be quickly known in order to reduce the time of waiting for idle equipment, the system must be set in manual operation in the contemporary method so that the equipment for the WIP is turned into an idle sate in advance to wait for the WIP to arrive. When the WIP arrives at the site, the equipment must be also manually switched back into a processing state to process the WIP.

It can be known from the foregoing description that to meet a process requirement of special lot, part of the equipments must be manually switched into the idle state to wait for the WIP to arrive. However, turning the equipment, which is usually expensive, into the idle state not only affects the production plan for general lot, but also decreases the throughput of the equipment itself, resulting in massive loss to the company.

### SUMMARY OF THE INVENTION

Accordingly, the present invention is directed to a method for reserving equipment which can reserve the equipment in advance for processing a special lot to reduce the time for processing the special lot.

The present invention is directed to a method for reserving equipment. The method includes the following steps. First, a process time of a special lot at each of a plurality of sites and a delivery time of the special lot between neighbouring sites are calculated according to a history record. Then, forecasting an arrival time of the special lot at each of the plurality of sites according to the process time and the delivery time. After that, calculating an occupation rate of each of a plurality of equipments at the one of sites according to the arrival time and an equipment status of each equipments. Finally, one of the equipments is reserved according to the occupation rate.

According to an embodiment of the present invention, the history record comprises a process period and a cycle time of processing each lot by each equipment, and calculation of the process time of the special lot at the each site comprises calculating the process time according to the process period and the cycle time of the each equipment.

According to an embodiment of the present invention, calculation of the delivery time of the special lot between neighbouring sites comprises calculating the delivery time according to a delivery mechanism and a delivery speed.

According to an embodiment of the present invention, forecast of the arrival time of the special lot at each of the plurality of sites comprises calculating a sum of the process time of all upstream sites with respect to the each site, and the delivery time between any neighbouring sites of the all upstream sites with respect to the each site, a result of which is used as the arrival time.

According to an embodiment of the present invention, the method further comprises determining whether or not the arrival time is less than a maximum reserve time after forecasting the arrival time of the special lot at each of the plurality of sites.

According to an embodiment of the present invention, the history record comprises a process period and a cycle time of processing each lot by each equipment, and calculation of the occupation rate of each equipment comprises: determining the equipment status of the each equipment to be a process state; and calculating the occupation rate according to the arrival time, a remainder process time, and an average cycle time of the each equipment. The remainder process time is calculated according to the process period of the each equipment and a current time. The occupation rate is calculated using the following equation:

Occupation rate=(Arrival_{—}T−Remainer_{—}T)/Avg_{—}TC

wherein, Arrival_T represents the arrival time, Remainder_T represents the remainder process time, and Avg_TC represents the average cycle time of the equipment.

According to an embodiment of the present invention, the history record comprises a process period and a cycle time of processing each lot by each equipment, and calculation of the occupation rate of each equipment comprises: determining the equipment status of the each equipment to be an idle state; and calculating the occupation rate according to the arrival time, the maximum process period of the each equipment, and an average cycle time of the each equipment. The occupation rate is calculated using the following equation:

Occupation rate=(Arrival_{—}T−Max_{—}TM)/Avg_{—}TC

wherein, Arrival_T represents the arrival time, Max_TM represents the maximum process period, and Avg_TC represents the average cycle time.

According to an embodiment of the present invention, reserving one of the equipments according to the occupation rate comprises reserving the equipment whose occupation rate is the lowest and less than 1.

According to an embodiment of the present invention, reserving one of the equipments according to the occupation rate comprises reserving one of the equipments according to a characteristic of each of the equipments.

According to an embodiment of the present invention, after reserving one of the equipments, the method further comprises: processing the special lot by the reserved equipment when the special lot arrives at the site; and recording a process period and a cycle time of processing the special lot by the reserved equipment in the history record.

In the present invention, the arrival time in each site of a special lot is forecasted according to a history record, and the equipment is reserved according to the arrival time and the equipment status of each of the equipments in the site. As a result, suitable equipments in the production line are reserved for the special lot, thus the time of waiting for available equipments can be eliminated, and the cycle time of processing the special lot can be reduced.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method for reserving equipment according to an embodiment of the present invention.

FIG. 2 is a flow chart illustrating a method of calculating the occupation rate according to an embodiment of the present invention.

FIG. 3 is a flow chart illustrating a method of calculating the occupation rate according to another embodiment of the present invention.

### DESCRIPTION OF THE EMBODIMENTS

With respect to those special lots on a semiconductor production line, the processing course and result of which is desired to be quickly known, if equipment is available for such special lots at each site can be reserved before the process flow thereof, it will absolutely reduce the time for waiting and increase throughput for processing the special lots. Based on this viewpoint, the present invention proposes a method for reserving equipment and a computer accessible storage media to store program thereof The present invention will become more apparent by describing in detail exemplary embodiments thereof with reference to the attached drawings.

The present invention will be described in the following embodiments in conjunction with a production line of a wafer factory, explaining operation of reserving the equipment to process the special lot before the special lot arrives at certain site to thereby reduce a cycle time of processing the special lot. For ease of explanation, it is assumed that in the following embodiments the production line of the wafer factory has two sites (i.e., first site and second site), and there are three equipments for processing lots in each site. However, it should be understood that the numbers of the sites and equipments are set forth for illustrative purposes only and are not intended to limit the invention to any particular number of sites or equipments. In other words, the reserving operation can be implemented with respect to any numbers of the equipments and sites, and thus the number herein is not intended to limit the scope of the present invention.

In this embodiment, after each lot arrives and is processed at each site, a process period and cycle time of corresponding equipment for the lot are recorded in a history record, wherein the process period is a time that the equipment consumes for processing a lot from start to finish, while the cycle time is a time that the equipment consumes for producing a lot (including the time for delivery of the lot) when the equipment operates under a continuous processing state.

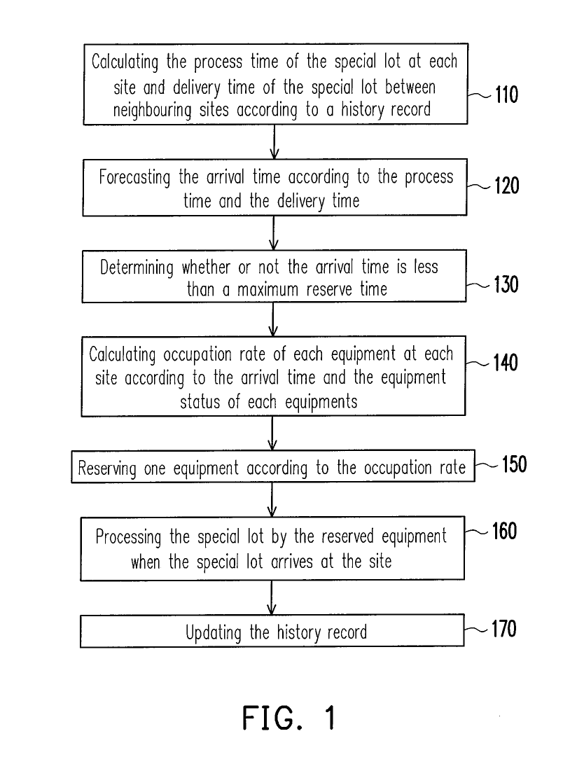

FIG. 1 is a flow chart illustrating the method for reserving equipment according to an embodiment of the present invention. Referring to FIG. 1, as shown in step 110, prior to processing of the lot, if the lot to be processed is determined to be a special lot through special marks, then the process time for the lot in each of the first and second sites is calculated according to the process period and cycle time in the history record with respect to the equipments at the first and second sites. Furthermore, the delivery time for delivering the lot from the first site to the second site is calculated according to a delivery mechanism and a delivery speed.

Next, in step 120, an arrival time at each site is forecasted using the process time and delivery time. In this embodiment, the process time of all upstream sites with respect to each site of the wafer production line, and the delivery time between any neighbouring sites of the all upstream sites with respect to each site of the wafer production line are obtained from the history record. Also in step 120, a sum of the process time and delivery time is used as the arrival time. Taking calculation of the arrival time at the second site as an example, if calculated according to the history record, the process time for the lot in the first site is two hours and the delivery time from the first site to the second site is one hour, then it is forecasted that the lot will arrive at the second site in three hours from its arrival at the first site.

As shown in step 130, after the arrival time is forecasted, it is determined whether or not the arrival time is less than a maximum reserve time. The maximum reserve time may, for example, be calculated in such a manner that a maximum lot process time is calculated using the process period and cycle time of each equipment in the wafer factory according to the history record, and the maximum reserve time is thereby determined according to the maximum lot process time. The purpose of determining whether or not the arrival time is less than the maximum reserve time is to avoid unnecessary reserve operation. In other words, the equipment reserve operation proceeds only when the arrival time is less than the maximum reserve time. For example, for a production line having site A, site B and site C, it is assumed that the process time for the special lot in site B is eight hours, and the process time in site C is two hours. Because the equipment in site C can process four other lots when the equipment in site B is processing one lot, it wouldn't make sense if equipments in site B and site C are reserved simultaneously; on the contrary, the throughput of the production line may be affected due to occupation of the equipments that could possibly be used for other lots. In another example, it is assumed that the special lot arrives at the first site at 2:50 p.m., and the process time for the special lot at the first site is three hours, while the process time at the second site is one hour. In this situation, the equipment at the second site can be reserved after the equipment at the first site starts processing for a period (e.g. 4:50 p.m.).

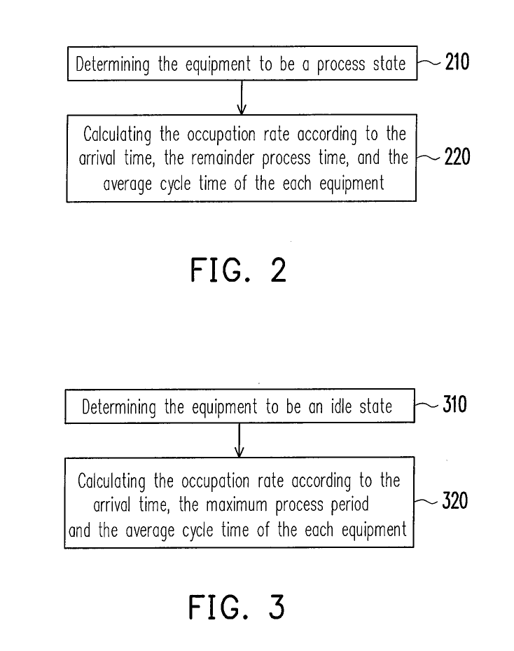

Next, as shown in step 140, an occupation rate of each equipment at each site is calculated according to the arrival time and the equipment status of each equipment at the site. FIG. 2 is a flow chart illustrating a method of calculating the occupation rate according to an embodiment of the present invention. Taking calculation of the occupation rate of the equipment at the second site as an example, if the equipment status of the equipment is determined to be a process state (which means there is other lot in process) in step 210, then the occupation rate is calculated according to the arrival time of the special lot, remainder process time of the equipment, and an average cycle time of the equipment in step 220. In this embodiment, the occupation rate of the equipment is calculated using the following equation:

Occupation rate=Arrival_{—}T−Remainder_{—}T)/Avg_{—}TC

wherein, Arrival_T represents the arrival time, Remainder_T represents the remainder process time, and Avg_TC represents for the average cycle time of the equipment. The remainder process time is calculated as a difference between an average process time of the equipment according to the history record and a current time.

For example, it is assumed that there are equipment X, equipment Y and equipment Z at the second site, and it is known the special lot will arrive at the second site in three hours through the calculation above, wherein the equipment X has been processing another lot for three hours, the equipment Y has been processing another lot for two hours, and the equipment Z has been processing another lot for one hour. It is further assumed that the average process time at the second site is four hours, which means the equipment X still needs one hour (4−3) to complete processing of current lot, the equipment Y still needs two hours (4−2) to complete processing of current lot, and the equipment Z still needs three hours (4−1) to complete processing of current lot. Assuming the average cycle time of the second site is four hours, the occupation rate of the equipment X, equipment Y, and equipment Z is calculated to be ½, ¼, and 0, according to the equation above.

FIG. 3 is a flow chart illustrating a method of calculating the occupation rate according to another embodiment of the present invention. In this embodiment, as shown in step 310, if the equipment is currently not processing any lot, that is to say, the equipment is in idle status, then the occupation rate of the equipment is calculated according to the arrival time of the special lot, the maximum process period of the equipment, and the average cycle time of the equipment. In this embodiment, the occupation rate of the equipment is calculated according to the following equation:

Occupation=(Arrival_{—}T−Max_{—}TM)/Avg_{—}TC

wherein, Arrival_T represents the arrival time of the special lot, Max_TM represents the maximum process period of the equipment, and the Avg_TC represents the average cycle time of the equipment. The maximum process period of the equipment is used as a parameter to calculate its occupation rate; this is because when the equipment is in idle state, the maximum process period can be used to indicate the time the equipment needs to wait for processing a next lot under the condition that it is not known when the next lot will arrive to be processed by the equipment.

Referring again to FIG. 1, in step 150, after the occupation rate of the each equipment at each site is calculated according to the equipment status and arrival time, the equipment reserve operation is performed according to the occupation rate. In the embodiment, the equipment whose occupation rate is the lowest and less than 1 is reserved for processing the special lot. Specifically, the lower the equipment occupation rate is, the shorter time the equipment waits for the special lot when the equipment is reserved. If the equipment occupation rate is 0, it means the equipment will be available for processing the special lot immediately after completion of the processing a previous lot, thereby achieving a maximum throughput of the equipment.

In another embodiment, in addition to reserving the equipment according to the equipment occupation rate, characteristics of the equipment itself can be relied on to determine whether or not to reserve the equipment. For example, processing of certain special lot may require the equipment to have a chemical medicine processing capability. Therefore, in reserving equipment, in addition to considering the low occupation rate, it must also be considered whether or not the equipment has the capability needed for processing the special lot.

It is noted that the above reserving operation is performed with respect to each load port, which is a unit to be reserved, of the equipment. That is to say, the reserved equipment will reserve a particular load port to wait for the special lot, but other unreserved load ports can be used to process general lots. Therefore, implementation of the equipment reserving method of the present invention does not affect the process flow of general lots.

Next, as shown in step 160, when arriving at the site, the special lot can be immediately processed with the reserved equipment, without waiting for equipment to be available. Finally, in step 170, the process period and cycle time of processing the special lot by the reserved equipment are recorded in the history record to timely update the history records.

In another embodiment, if exception occurs during the course of processing the slot at one site, then the reservation of the equipment at the site can be modified, and according to current situation, the equipment reserve operation can be re-performed before the special lot arrives. As such, the exception will not adversely affect the plan for processing the special lot.

It is noted that the above-described equipment reserve method can be implemented, for example, in a computer system. In other words, a computer program may be designed in light of the embodiments described above, and the computer program is stored in a computer accessible storage media (e.g. optical disk and hard disk) and loaded into the computer system, thus allowing the computer system to execute the equipment reserve method according to the embodiments described above.

In summary, the method for reserving equipment and the computer accessible storage media to store program thereof according to the present invention have at least the following advantages:

1. Through reservation of the equipment in advance, the special lot can be quickly and smoothly processed with the reserved equipment when arriving at the site, thereby reducing the cycle time of processing the special lot.

2. Each load port of the equipment is a unit to be reserved, thereby increasing the throughput of the equipment without adversely affecting the processing of general slots.

3. The reservation of the equipment can be modified during processing, thus making the processing of the special lot more flexible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for reserving equipment, comprising:
calculating a process time of a special lot at each of a plurality of sites and a delivery time of the special lot between neighbouring sites according to a history record;
forecasting an arrival time of the special lot at each of the plurality of sites according to the process time and the delivery time;
calculating an occupation rate of each of a plurality of equipments at each of sites according to the arrival time and a equipment status of each equipments; and
reserving one of the equipments according to the occupation rate.

2. The method for reserving equipment according to claim 1, wherein the history record comprises a process period and a cycle time of processing each lot by each equipment, and calculating the process time of the special lot at the each site comprises calculating the process time according to the process period and the cycle time of the each equipment.

3. The method for reserving equipment according to claim 1, wherein the step of calculating the delivery time of the special lot between neighbouring sites comprises calculating the delivery time according to a delivery mechanism and a delivery speed.

4. The method for reserving equipment according to claim 1, wherein the step of forecasting the arrival time of the special lot at each of the plurality of sites comprises calculating a sum of the process time of all upstream sites with respect to the each site, and the delivery time between any neighbouring sites of the all upstream sites with respect to the each site, a result of which is used as the arrival time.

5. The method for reserving equipment according to claim 1, further comprising a step of determining whether or not the arrival time is less than a maximum reserve time after forecasting the arrival time of the special lot at each of the plurality of sites.

6. The method for reserving equipment according to claim 1, wherein the history record comprises a process period and a cycle time of processing each lot by each equipment, and the step of calculating the occupation rate of each equipment comprises:
determining the equipment status of the each equipment to be a process state; and
calculating the occupation rate according to the arrival time, a remainder process time, and an average cycle time of the each equipment.

7. The method for reserving equipment according to claim 6, wherein the occupation rate is calculated using following equation:
occupation rate=(Arrival_{—}T−Remainder_{—}T)/Avg_{—}TC
wherein Arrival_T represents the arrival time, Remainder_T represents the remainder process time, and Avg_TC represents the average cycle time of the equipment.

8. The method for reserving equipment according to claim 6, further comprising calculating the remainder process time according to the process period of the each equipment and a current time.

9. The method for reserving equipment according to claim 1, wherein the history record comprises a process period and a cycle time of processing each lot by each equipment, and the step of calculating the occupation rate of each equipment comprises:
determining the equipment status of the each equipment to be an idle state; and
calculating the occupation rate according to the arrival time, the maximum process period of the each equipment, and an average cycle time of the each equipment.

10. The method for reserving equipment according to claim 9, wherein the occupation rate is calculated using following equation:
occupation rate=(Arrival_{—}T−Max_{—}TM)/Avg_{—}TC
wherein Arrival_T represents the arrival time, Max_TM represents the maximum process period, and Avg_TC represents the average cycle time.

11. The method for reserving equipment according to claim 1, wherein reserving one of the equipments according to the occupation rate comprises reserving the equipment whose occupation rate is the lowest and less than 1.

12. The method for reserving equipment according to claim 1, wherein the step of reserving one of the equipments according to the occupation rate comprises reserving one of the equipments according to a characteristic of each of the equipments.

13. The method for reserving equipment according to claim 1, after reserving one of the equipments, further comprising:
processing the special lot by the reserved equipment when the special lot arrives at the site; and
recording a process period and a cycle time of processing the special lot by the reserved equipment in the history record.
